(19) United States
(12) Patent Application Publication
(10) Pub. No.: US 2007/0207294 A1
(43) Pub. Date: Sep. 6, 2007

(54) SHAPEABLE ABSORBENT MAT

(75) Inventors: Raymond L. Fedeli, Altoona, PA (US); Heidi Gretchen Shetler, Altoona, PA (US); Patrick E. Healy, Gallitzin, PA (US)

Correspondence Address: PIETRAGALLO, BOSICK & GORDON LLP, ONE OXFORD CENTRE, 38TH FLOOR, 301 GRANT STREET, PITTSBURGH, PA, 15219-6404, US

(73) Assignee: New Pig Corporation, Tipton, PA (US)

(21) Appl. No.: 11/681,874

(22) Filed: Mar. 5, 2007

Related U.S. Application Data
(60) Provisional application No. 60/779,325, filed on Mar. 3, 2006.

(51) Int. Cl. B32B 23/02

(52) U.S. Cl. 428/192

(57) ABSTRACT

A shapeable absorbent mat having an absorbent layer and a forming layer secured to the absorbent layer is disclosed. The forming layer is made from a shapeable material, which may be liquid impermeable. The absorbent layer may be secured to the forming layer by an adhesive layer disposed between the absorbent layer and the forming layer. The shapeable absorbent mat formed fitted to almost any shape which makes the mat well suited be wrapped around pipes, fittings and other equipment. The shapeable absorbent mat may also be shaped into a pan to catch leaks and drips. Additionally, the shapeable absorbent mat may be used forming side up to form a trough to channel liquids away.

### CROSS REFERENCE TO RELATED APPLICATION

This application claims the benefit of U.S. Provisional Patent Application Ser. No. 60/779,325, filed Mar. 03, 2006, which is herein incorporated by reference.

### FIELD OF THE INVENTION

The present invention relates to absorbents for catching leaks, drip and spills of water, oil-based liquid and other non-aggressive fluids.

### BACKGROUND INFORMATION

Hoses, pipes and other equipment often develop leaks in hard to reach areas. These leaks are difficult to catch using standard absorbents, such as mats or absorbent socks made of supple material, which bends easily but does not retain its shape. This attribute makes the use of standard absorbents in many applications inadequate. For example, trying to contain drips from leaking pipes is particularly difficult using a non-shapeable absorbent mat. Some other article, like a tape or a band, would be needed to hold the mat in place and once in place. Furthermore, once saturated with liquid, the mat will leach and drip onto whatever is below the leak.

Another example where standard absorbents are particularly ineffective is in tight spaces or hard to reach areas around equipment. Often standard absorbents are packed into these areas and only removed once saturated leaving behind a liquid soaked floor. Alternatively, in order to keep the area dry the absorbents have to be removed prematurely before reaching their absorbent capacity.

Another example where standard absorbents have shown to be inadequate is when a leaking liquid merely needs diverted to a nearby area or container to remedy the leak. Standard absorbents were only capable of absorbing and not diverting the liquid, thus some other article was required to perform this function.

The present invention has been developed in view of the foregoing.

### SUMMARY OF THE INVENTION

The present invention provides a shapeable absorbent mat having an absorbent layer secured to a forming layer. The forming layer may be made from a formable material, which is sometimes liquid impermeable. The absorbent layer may be secured to the forming layer by an adhesive layer disposed between the absorbent layer and the forming layer. The shapeable absorbent mat may be form fitted to almost any shape, which makes the mat well suited to be wrapped around pipes, fittings and other equipment. The shapeable absorbent mat may also be shaped into a pan to catch leaks and drips. Additionally, when the forming layer is also liquid impervious, the shapeable absorbent mat may be used forming side up to form a trough to channel liquids away.

An aspect of the present invention provides a shapeable absorbent mat comprising an absorbent layer and a shapeable forming layer secured to the absorbent layer.

Another aspect of the present invention provides a method of using an absorbent mat to absorb a liquid comprising the steps of providing a shapeable absorbent mat and deforming the shapeable absorbent mat to contain the liquid.

Another aspect of the present invention provides a method of using a shapeable absorbent mat having an absorbent layer and a forming layer to divert a liquid comprising the steps of deforming the shapeable absorbent mat into a trough wherein the liquid impervious layer forms the interior of the trough which contacts the liquid.

These and other aspect will become more apparent from the following description.

### BRIEF DESCRIPTION OF THE DRAWINGS

FIG. 1 illustrates a perspective view shapeable absorbent mat according to one embodiment the present invention showing the absorbent layer on top and the forming layer on the bottom with an adhesive layer between the absorbent layer and forming layer.

FIG. 2 illustrates a cross section of the shapeable absorbent mat according to one embodiment of the present invention showing the absorbent layer, adhesive layer and forming layer.

FIG. 3 illustrates a cross section of a shapeable absorbent mat having the absorbent layer and forming layer secured by a taped edge.

FIG. 4 illustrates how a shapeable absorbent mat according to one embodiment of the present invention may be molded around a leaking pipe.

FIG. 5 illustrates how a shapeable absorbent mat according to one embodiment of the present invention may be folded into a pan shape for containing a leaking fluid according to one embodiment of the present invention.

FIG. 6 illustrates a shapeable absorbent mat molded into a trough to direct a leaking liquid into a container according to one embodiment of the present invention.

FIG. 7 illustrates a shapeable absorbent mat with an expanded metal forming layer according to one embodiment of the present invention.

FIG. 8 illustrates a shapeable absorbent mat with a forming layer made of metallic strips according to one embodiment of the present invention.

FIG. 9 illustrates a shapeable absorbent mat with a forming layer disposed between two absorbent layers according to one embodiment of the present invention.

FIG. 10 illustrates the shapeable absorbent mat of FIG. 9 with a barrier layer to prevent leaching of absorbed liquid according to one embodiment of the present invention.

### DETAILED DESCRIPTION

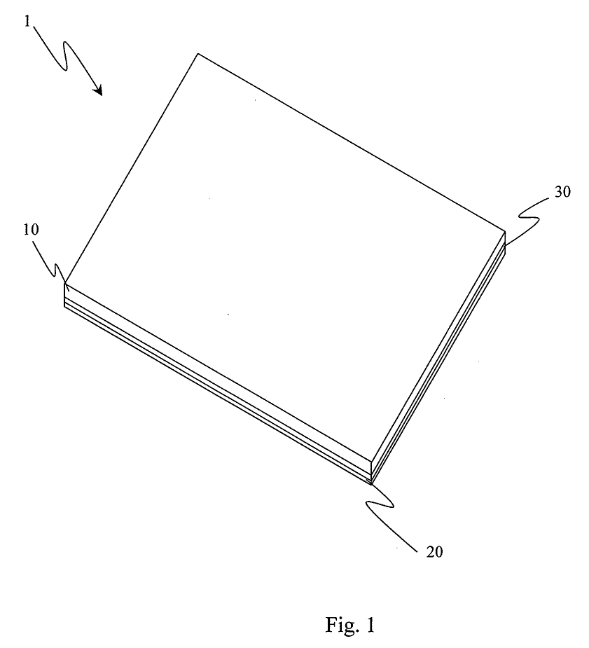

Referring now to FIG. 1, a shapeable absorbent mat 1 is shown according to one embodiment of the present invention. The mat 1 may be a sheet-like material having a generally planar structure. The mat 1 may be made from two or more layers. As used herein, the term layer refers to a thickness of material covering a surface. As seen in FIG. 1, the mat 1 has an absorbent layer 10 and a forming layer 20. An adhesive layer 30 may be included between the absorbent layer 10 and the forming layer 20 to hold the absorbent layer 10 and forming layer 20 together.

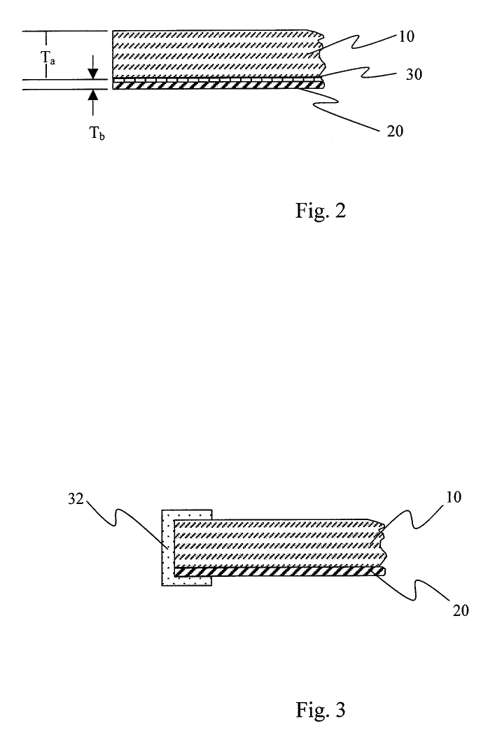

The absorbent layer 10 may be formed from any material suitable for absorbing oil-based and/or water-based fluids, for example water, oil, and solvents. Examples of suitable material for use as an absorbent layer 10 include natural or synthetic fibrous material or combinations thereof, for example cellulosic material or non-woven polypropylene. The absorbent layer 10 has a thickness, shown as Tₐ in FIG. 2, of about 0.01 inch to about 0.5 inch, for example 0.1 inch.

Still referring to FIG. 2, the forming layer 20 may be made a suitable shapeable material. As used herein, the term shapeable refers to a material characteristic in which a material changes from an original shape to a new shape in response to a pressure or stress and the material does not return to its original shape when the pressure or stress is removed. By way of example, the forming layer 10 may be made from aluminum foil, aluminum alloy foil, sheet steel, copper, tin, nickel, brass or other metals. The forming layer 20 serves as a structural layer of the mat 1 giving the mat its shapeable characteristics. The forming layer 20 is structured to provide deformation capabilities of the mat. In a preferred embodiment, the forming layer 10 is also liquid impervious. However, in certain later described embodiments, the forming layer is permeable. The forming layer has a thickness, shown as T_{b} in FIG. 2, which is important to the functionality of mat 1. The thickness of the forming layer will be dependent on the material used. If the forming layer is made too thick the mat 1 will not be able to be bent into an a appropriate shape. Furthermore, the forming layer will not be able to be cut by common means, like scissors. If the forming layer is made too thin, the mat 1 will not retain its shape when molded. The forming layer 10 will also likely be easily torn allowing unintended escape of contained liquid. When aluminum foil is used as the forming layer, T_{b} is about 1 mil to about 6 mil, for example 3 mil. T_{b} is somewhat dependant on the thickness of the absorbent layer 10. As the thickness and/or resistance to deformation of the absorbent layer 10 increases, the thickness and deformation ability of the forming layer must correspond. For example, an aluminum foil forming layer 20 with a T_{b} of 3 mil adequately deforms a mat 1 having a polypropylene absorbent layer 10 with a Tₐ of 0.1 inch.

The adhesive layer 30 adheres the absorbent layer 10 to the forming layer 20. The adhesive layer 30 may include any adhesive system suitable for adhering the absorbent layer 10 to the forming layer 20. For example, toughened acrylic, cyanoacrylate, two-part epoxy, hot melt adhesive, polyurethane, polyethylene, polypropylene, silicone rubber, spray on water-based adhesives and solvent-based adhesives may be suitable adhesives.

In one embodiment the adhesive layer is a pressure sensitive adhesive such as a two-sided tape. In certain embodiments, the adhesive is applied as one continuous layer between the absorbent layer 10 and forming layer 20. In other embodiments, the adhesive is applied to discrete sections; for example, the adhesive may be applied in strips, zones or other discontinuous pattern.

In another embodiment of the present invention, the absorbent layer 10 is affixed to the forming layer 20 mechanically. For example, the absorbent layer 10 may be sewn on to the forming layer 10 or held to the forming layer by mechanical fasteners.

Referring now to an embodiment of the present invention shown FIG. 3, the absorbent layer 10 is held to the forming layer 20 by a taped edge 32 around a periphery of the mat 1. The taped edge comprises a one-sided tape applied around the peripheral edge of the mat 1. An adhesive side of a portion of the tape is in contact with an exterior surface of the forming layer 20. The one-sided tape is wrapped around an edge of the mat 1 so that the adhesive side of a portion of the tape is in contact with an exterior surface of the absorbent layer 10. The taped edge 32 may be made of a rubber, vinyl, neoprene or other flexible tape. The taped edge 32 may additionally be stretched or shrunk-fit about the perimeter of the mat 1.

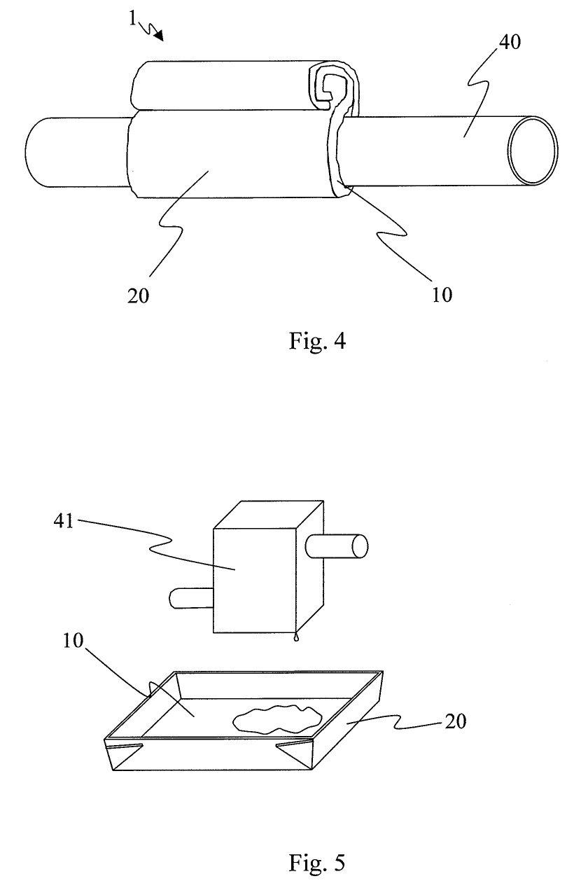

Referring now to FIGS. 4, a non-limiting example of how the mat 1 may be used according to one embodiment of the present invention is shown. The mat 1 may be wrapped around a leaking pipe to absorb and contain the leak until permanent repairs can be made. The mat 1 may be wrapped around the pipe 40 with the absorbent layer 10 in contact with the pipe 40 and then the mat folded or rolled in an interlocking fashion securing the mat 1 in place.

Referring now to FIGS. 5, another non-limiting example of how the mat 1 may be used according to one embodiment of the present invention is shown. The mat 1 may folded into a box or other shape to contain a leaking fluid from gearbox 41. The shapeable nature of the mat 1 allows many shapes to be from a standard sheet-like mat 1. The ability to bend and hold its shape also increases the absorbent capacity of the mat 1 by utilizing the impermeable forming layer as a fluid container. The impermeable forming layer 20 prevents liquids from leaching through the mat 1.

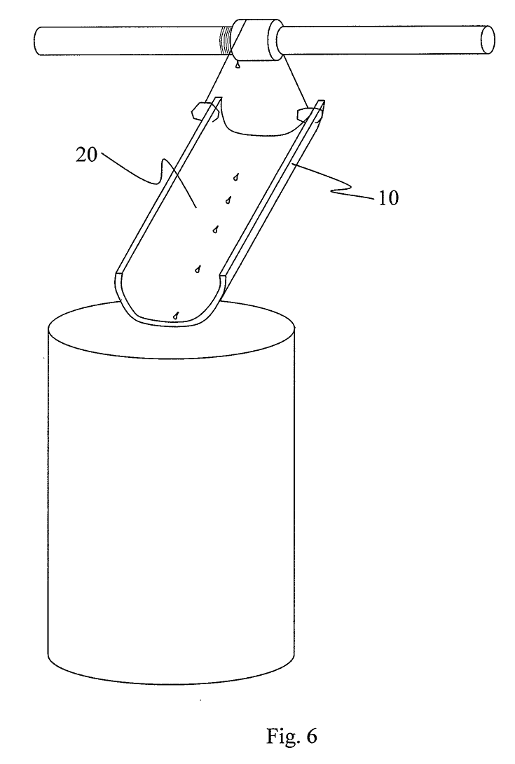

FIG. 6 shows another beneficial aspect of one embodiment of the present invention. The mat 1 may used as a gutter or trough to divert leaking fluid by simply shaping the mat 1 into an appropriate form so that the forming layer 20 creates the interior surface of the trough. The mat 1 embodied in the form of a trough can now be supported in any appropriate fashion to divert leaking fluid to a more desirable location. As shown in FIG. 6 it may be more desirable to divert the fluid to a separate container 42 or the mat 1 may simply divert fluid away from equipment or personnel below the leak.

The mat 1 may be packaged as individual pads or may be packaged as a continuous roll. As mentioned above, one embodiment of the mat 1 may be cut to appropriate sizes with scissors.

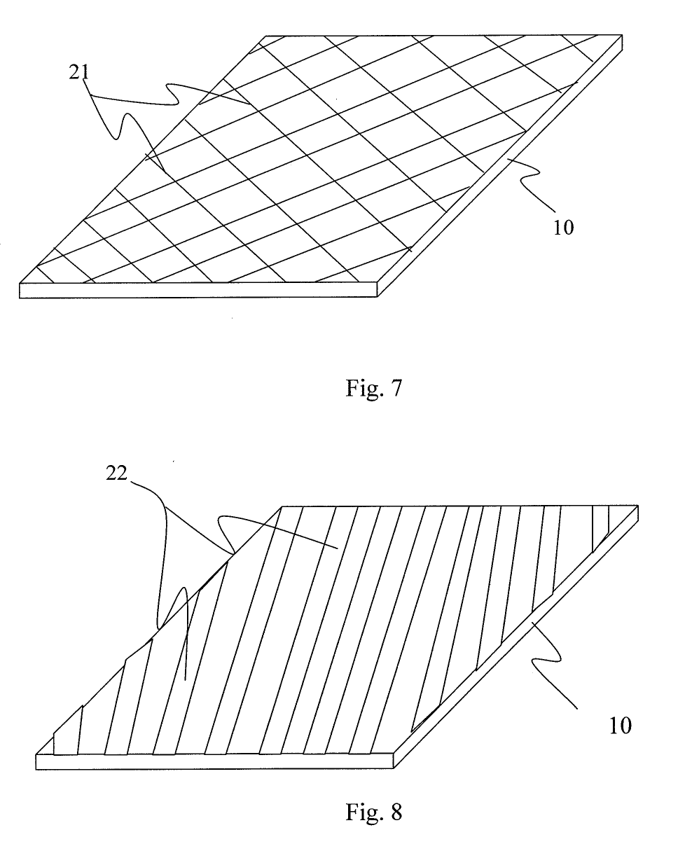

Referring now FIGS. 7 and 8, a shapeable mat 1 may be made from an absorbent layer 20 affixed to a permeable forming layer 20 such as expanded metal 21 shown in FIG. 8. According to another embodiment of the present invention, the absorbent layer may be affixed to multiple sections or strips 22 comprising a forming layer 20. In yet another embodiment of the present invention, wire may be incorporated into or affixed to the absorbent layer to create a forming layer.

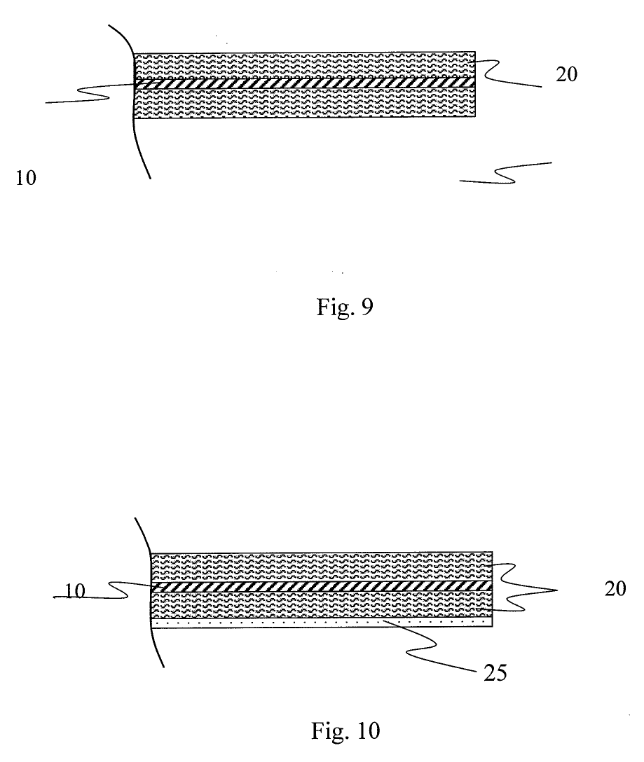

The forming layer 10 may be located between multiple absorbent layers 20 as shown in FIG. 9. In this embodiment, the forming layer 20 may be any of the aforementioned structures or materials. Although not detailed in FIG. 9, the absorbent layers 10 may be affixed to the forming layer 10 by any of the above-described means. Additionally, in this configuration one absorbent layer 10 may be bonded or mechanically affixed to another absorbent layer 10.

FIG. 10 illustrates the shapeable mat 1 of FIG. 9 with an additional barrier layer 25. The barrier layer 25 is a liquid impermeable layer added to prevent leaching when a permeable forming layer 20 is used. The barrier layer 25 may be affixed as above described and may be made from any flexible, impermeable material, for example a plastic, such as polyethylene, polypropylene, cellophane, or polyvinylidene chloride.

Whereas particular embodiments of this invention have been described above for purposes of illustration, it will be evident to those skilled in the art that numerous variations of the details of the present invention may be made without departing from the invention as defined in the appended claims.

1. A shapeable absorbent mat comprising:
at least one absorbent layer; and
a shapeable, forming layer secured to the absorbent layer.

2. The shapeable mat of claim 1 wherein the forming layer is liquid impermeable.

3. The shapeable mat of claim 1 wherein the forming layer is a metal foil.

4. The shapeable mat of claim 1 wherein the forming layer is an aluminum foil.

5. The shapeable mat of claim 4 wherein the forming layer has a thickness of about 1 mil to about 6 mils.

6. The shapeable mat of claim 4 wherein the forming layer has a thickness of about 3 mils.

7. The shapeable absorbent mat of claim 1 further comprising an adhesive layer disposed between the absorbent layer and the forming layer.

8. The shapeable absorbent mat of claim 7 wherein the adhesive layer comprises a water based spray on adhesive adhesive.

9. The shapeable absorbent mat of claim 7 wherein the adhesive layer comprises a continuous layer of adhesive between the absorbent layer and the forming layer.

10. The shapeable absorbent mat of claim 7 wherein the adhesive layer comprises discrete sections of adhesive disposed between the absorbent layer and the forming layer.

11. The shapeable absorbent mat of claim 7 wherein the adhesive layer comprises two-sided tape.

12. The shapeable absorbent mat of claim 1 wherein the shapeable absorbent mat can be cut by scissors.

13. The shapeable absorbent mat of claim 1 further comprising a taped edge for securing the forming layer to the absorbent layer, wherein the taped edge comprises one-sided tape wrapped around a periphery of the shapeable absorbent mat.

14. The shapeable absorbent mat of claim 1 wherein the absorbent layer comprises polypropylene.

15. The shapeable absorbent mat of claim 14 wherein the absorbent layer has a thickness of about 0.01 inch to about 0.5 inch.

16. The shapeable absorbent mat of claim 14 wherein the absorbent layer has a thickness of about 0.1 inch.

17. The shapeable absorbent mat of claim 1 wherein the forming layer is expanded metal.

18. The shapeable absorbent mat of claim 17 wherein the forming layer is disposed between and affixed to two absorbent layers.

19. The shapeable absorbent mat of claim 17 further comprising a liquid impervious barrier layer affixed to an exterior surface of one absorbent layer.

20. A method of using an absorbent mat to absorb a liquid comprising the steps of:
providing a shapeable absorbent mat; and
deforming the shapeable absorbent mat to contain the liquid.

21. The method of using an absorbent mat of claim 20 wherein the absorbent mat is deformed around a pipe.

22. The method of using an absorbent mat of claim 20 wherein the absorbent mat is deformed into a pan, box or container.

23. A method of using a shapeable absorbent mat having an absorbent layer and a liquid impervious forming layer to divert a liquid comprising the steps of deforming the shapeable absorbent mat into a trough wherein the liquid impervious layer forms the interior of the trough which contacts the liquid.
